(19) United States
(12) Patent Application Publication
(10) Pub. No.: US 2015/0122394 A1
(43) Pub. Date: May 7, 2015

(54) FLEXIBLE BEAD WIRE FOR TYRE

(71) Applicants: COMPAGNIE GENERALE DES ETABLISSEMENTS MICHELIN, CLERMONT-FERRAND (FR); Michelin Recherche et Technique S.A., GRANGES-PACCOT (CH)

(72) Inventors: Jean-Michel Huyghe, Clermont-Ferrand (FR); Laurent Bucher, Clermont-Ferrand (FR); Antonio Delfino, Clermont-Ferrand (FR); Jean-Paul Meraldi, Clermont-Ferrand (FR); Thibault Rapenne, Clermont-Ferrand (FR)

(73) Assignee: Michelin Recherche et Technique S.A., GRANGES-PACCOT (CH)

(21) Appl. No.: 14/405,024

(22) PCT Filed: Jun. 5, 2013
(86) PCT No.: PCT/EP2013/061585

§ 371 Date: Dec. 2, 2014

(30) Foreign Application Priority Data
Jun. 7, 2012 (FR) 1255295

(51) Int. Cl. B60C 15/04; D02G 3/40; D02G 3/48; D02G 3/36

(52) U.S. Cl. CPC B60C 15/04; D02G 3/36; D02G 3/40; D02G 3/48; B60C 2015/042; B60C 2015/044
USPC 152/547; 57/224; 57/232

(57) ABSTRACT

A bead wire for a tyre includes a core and an outer layer. The core includes a plurality of circumferential windings of at least one core yarn, with each core yarn including a core multifilament textile fibre embedded in an organic core matrix. The outer layer includes a single outer-layer yarn, with the outer-layer yarn including an outer-layer multifilament textile fibre embedded in an organic outer-layer matrix. The outer-layer yarn is wound around the core.

The invention relates to bead wires for tyres. It applies to any type of tyre for any type of vehicle.

Conventionally, a tyre comprises two circumferential beads that are intended to allow the tyre to be fitted on the rim. Each bead comprises an annular reinforcing bead wire.

The prior art discloses a tyre for a ground vehicle, comprising a bead wire comprising a core and a layer of a steel wire wound around the core. The core is made up of a steel monofilament. The steel monofilament is bent round on itself and its two ends are welded in order to form an approximately circular ring.

During steps of transport and storage, such a tyre takes up a given volume. Thus, for a given transport or storage volume, the number of tyres that can be transported and stored in this given transport or storage volume remains relatively limited, thereby increasing the logistics costs and thus the cost of the tyre.

The aim of the invention is to provide a tyre that takes up less space during the steps of transport and storage.

To this end, one subject of the invention is a bead wire for a tyre, comprising:
a core comprising a plurality of circumferential windings of at least one core yarn, each core yarn comprising a core multifilament textile fibre embedded in an organic core matrix,
an outer layer comprising a single outer-layer yarn comprising an outer-layer multifilament textile fibre embedded in an organic outer-layer matrix, the outer-layer yarn being wound around the core.

The core and the outer layer have an increased capability of elastic deformation, which is enhanced by the plurality of windings of the core. Specifically, by increasing the number of windings and for a predetermined size of the bead wire, the cross section of each winding, and thus the stiffness of the cross section of each winding, is reduced and the critical bending radius of curvature of the core is decreased.

The combination of firstly the materials of which the core and the outer layer are made and secondly the plurality of windings makes it possible to obtain a bead wire having an excellent capability of elastic deformation.

Thus, it is possible to bend the tyres with no risk of irreversible plastic deformation. Thus, the volume taken up by the tyre, in particular during the steps of transport and storage, and thus also the logistics costs are limited.

In addition, the bead wire according to the invention is relatively light. Specifically, the nature of the materials of which the core and the outer layer are made makes it possible to reduce the mass of the bead wire according to the invention by 50 to 70% compared with that of a bead wire with a metal core and layer, while retaining its mechanical properties, in particular force at break.

A circumferential winding is understood to be a winding around the main axis of the bead wire, said winding extending in the circumferential direction around this axis. The winding can form a substantially planar circle or even oscillate around a plane perpendicular to the axis of the bead wire.

By definition, a textile fibre is non-metallic. A multifilament textile fibre comprises elementary textile filaments that are arranged side by side and oriented in a substantially unidirectional manner. The elementary filaments are thus more or less parallel to one another, apart from the occasional overlap.

Each textile fibre, in particular core textile fibre and outer-layer textile fibre, reinforces the organic matrix. Such fibres are chosen for example from the group consisting of polyvinyl alcohol fibres, aromatic polyamide (or “aramid”) fibres, polyester fibres, aromatic polyester fibres, polyethylene fibres, cellulose fibres, rayon fibres, viscose fibres, polyphenylene benzobisoxazole (or “PBO”) fibres, polyethylene naphthenate (“PEN”) fibres, glass fibres, carbon fibres, silica fibres, ceramic fibres, and mixtures of such fibres. Use will preferably be made of fibres chosen from the group consisting of glass fibres, carbon fibres and mixtures of such fibres.

Preferably, the core fibre is a glass fibre. Preferably, the outer-layer fibre is a glass fibre.

An organic matrix is understood to be any matrix comprising, by weight, more than 50%, preferably more than 75% and more preferably more than 90% organic material. The organic matrix may contain minerals and/or metals that come from its manufacturing process, but also deliberately added mineral and/or metal additives. Thus, an organic matrix may be for example a thermosetting polymeric matrix, for example based on an unsaturated polyester, polyepoxide, a phenolic derivative or aminoplast, or else a thermostable polymeric matrix, for example based on cyanate, poly(bismaleimide), polyimide, polyamidoimide, or else a thermoplastic polymeric matrix, for example based on polypropylene, polyamide, saturated polyester, polyoxymethylene, polysulphone and polyethersulphone, polyether ketone and polyether ether ketone, polyphenylene sulphide, polyetherimide, or else thermoplastic or crosslinked elastomer, for example based on polyurethane, silicone or rubber or even an organic matrix that results from a mixture of these matrices.

Preferably, the organic core matrix is a thermoset, preferably crosslinked, resin. Preferably, the organic outer-layer matrix is a thermoset, preferably crosslinked, resin. It is for example a resin that is crosslinkable by ionizing radiation, such as for example ultraviolet-visible radiation, a beam of accelerated electrons or X rays. A composition comprising a resin that is crosslinkable by a peroxide may also be chosen, it being possible for the subsequent crosslinking then to be carried out, in due course, by means of applied heat, for example by the action of microwaves. Preferably, use is made of a composition of the type that can be cured by ionizing radiation, it being possible for the final polymerization to be triggered and controlled easily by means of an ionizing treatment, for example of the UV or UV-visible type. As crosslinkable resin, use is more preferably made of a polyester resin (i.e. based on unsaturated polyester) or a vinyl ester resin. Even more preferably, use is made of a vinyl ester resin.

In one embodiment, the materials of which the core and the outer layer are made are more or less identical. In another embodiment, they are different.

In one embodiment, the core fibre and outer-layer fibre are more or less identical. In another embodiment, they are different.

In one embodiment, the organic core matrix and organic outer-layer matrix are more or less identical. In another embodiment, they are different.

In one embodiment, the core comprises a single core yarn, and is preferably made up of a single yarn.

In one variant, the core comprises a plurality of windings of this single yarn. Each winding then forms a coil.

In one embodiment, the core comprises a plurality of separate core yarns. Each yarn can be wound to form one or more coils.

In one variant, each yarn is monolithic. The term “monolithic” is understood to mean that each yarn has no discontinuities of material or joints on the macroscopic scale. Since each yarn is monolithic, the core is less fragile than the core of the prior art bead wire, which has a weakness at the point at which its ends are welded. Preferably, the elementary filaments are distributed homogeneously throughout the volume of the torus.

In one variant, the yarns are assembled by cabling. In this variant, the yarns are wound together in a helix and do not undergo a twist about their own axis.

In another variant, the yarns are assembled by twisting. In this variant, the yarns are wound together in a helix and undergo both a collective twist and an individual twist about their own axis, thereby generating an untwisting torque on each of the yarns.

In yet another variant, the core comprises a plurality of monolithic toruses that are juxtaposed parallel to one another.

Advantageously, the material of which each core yarn is made has a yield strength measured in accordance with the standard ISO 14125 at 23° C. greater than or equal to 800 MPa, preferably greater than or equal to 1000 MPa and more preferably greater than or equal to 1200 MPa.

Advantageously, the material of which the outer-layer yarn is made has a yield strength measured in accordance with the standard ISO 14125 at 23° C. greater than or equal to 800 MPa, preferably greater than or equal to 1000 MPa and more preferably greater than or equal to 1200 MPa.

By virtue of the high yield strength of the core material and outer-layer material, the flexibility of the bead wire is improved and the risk of plasticization of the bead wire during the steps of transport and storage is further reduced.

Advantageously, the material of which each core yarn is made has a Young's modulus measured in accordance with the standard ISO 14125 at 23° C. less than or equal to 100 GPa, preferably less than or equal to 75 GPa and more preferably less than or equal to 50 GPa.

Advantageously, the material of which each outer-layer yarn is made has a Young's modulus measured in accordance with the standard ISO 14125 at 23° C. less than or equal to 100 GPa, preferably less than or equal to 75 GPa and more preferably less than or equal to 50 GPa.

The low Young's modulus of the core material and outer-layer material makes it possible to obtain a core and an outer layer that are strong in terms of deformation,

Preferably, the combination of the high yield strength and the low Young's modulus gives the core and the outer layer an excellent capability of deformation in the elastic domain.

Advantageously, the ratio of the contribution of the core to the mass of the bead wire to the contribution of the core to the force at break of the bead wire is less than or equal to 2, preferably less than or equal to 1.5 and more preferably less than or equal to 1. An increase in the mass of the bead wire causes a relatively large increase in the force at break compared with the same increase in the mass of the prior art bead wire.

The contribution of the core to the force at break is defined by the ratio of the force at break of the core alone to the force at break of the bead wire. The contribution of the core to the mass of the bead wire is defined by the ratio of the mass of the core alone to the mass of the bead wire.

In order to determine the ratio of contribution to the force at break, the force at break of the bead wire or of the core (maximum load in N) can be measured by any kind of method that is generally used. Use could be made for example of a method in accordance with the standard ISO 6892, 1984 on a rectilinear specimen of the bead wire, or even a method in accordance with the bead wire tensile test described below.

Advantageously, the ratio of the contribution of the core to the mass of the bead wire to the contribution of the core to the force at break of the bead wire is greater than or equal to 0.25, preferably greater than or equal to 0.4 and more preferably greater than or equal to 0.5. Thus, the bead wire has an excellent distribution of the contributions to the mass and to the force at break between the core and the outer layer.

Preferably, the ratio of the contribution of the core to the mass of the bead wire to the contribution of the core to the force at break of the bead wire is in at least one of the ranges [0.25; 2], [0.4; 2], [0.5; 2], [0.25; 1.5], [0.4; 1.5], [0.5; 1.5], [0.25; 1], [0.4; 1] and [0.5; 1].

More preferably, the ratio of the contribution of the core to the mass of the bead wire to the contribution of the core to the force at break of the bead wire is equal to 1.

Preferably, the contribution of the core to the force at break of the bead wire is greater than or equal to 15%, preferably greater than or equal to 20% and more preferably greater than or equal to 25%. Thus, the contribution of the core of the bead wire to the force at break of the bead wire is greater than the contribution of the core of the prior art bead wire to the force at break of the prior art bead wire. At constant mechanical properties, the bead wire is thus lighter.

Optionally, the contribution of the core to the force at break of the bead wire is less than or equal to 75%. The contribution to the force at break thus remains relatively well distributed between the core and the outer layer.

Preferably, the contribution of the core to the mass of the bead wire is greater than or equal to 15%, preferably greater than or equal to 20% and more preferably greater than or equal to 25%.

Optionally, the contribution of the core to the mass of the bead wire is less than or equal to 75%. The contribution to the mass of the bead wire thus remains relatively well distributed between the core and the outer layer.

Advantageously, the ratio of the diameter of the torus defined by the core to the diameter of the torus defined by the bead wire is greater than or equal to 0.3, preferably greater than or equal to 0.45 and more preferably greater than or equal to 0.5. Thus, it is possible to obtain bead wires comprising a relatively compact core and having excellent mechanical properties, in particular force at break.

Preferably, the force at break of the bead wire is between 1600 daN and 2600 daN, inclusive, preferably between 1800 daN and 2400 daN, inclusive, and more preferably between 2000 daN and 2200 daN, inclusive.

The force at break of the bead wire or of the core (maximum load in N) is measured at 23° C., preferably using a circumferential tensile test, referred to as the bead wire tensile test, on a tensile testing machine comprising twelve radially mobile sectors. During this test, which is carried out under quasi-static conditions, the bead wire or core to be tested is positioned around the sectors. The simultaneous and progressive movement of the sectors has the effect of exerting a radial force of increasing intensity on the bead wire or core. The movements of the sectors are followed by three force sensors that measure the forces exerted on the bead wire or core. The force at break is determined when an element of the bead wire breaks (in the case of the test on the bead wire) or when the core breaks (in the case of the test on the core). The acquisition frequency is equal to 100 Hz. The force at break value that is retained is the average of the three values measured by the three sensors.

According to preferred features of the bead wire:
The diameter of each core yarn and/or outer-layer yarn is between 0.5 and 4 mm.
The diameter of each elementary filament of each core multifilament textile fibre and/or outer-layer multifilament textile fibre is between 2 and 30 μm.
Each core multifilament textile fibre and/or outer-layer multifilament textile fibre is continuous. The term “continuous”, in opposition to discontinuous, is understood as meaning that for a predetermined length of the fibre, for example 5 cm, at least 80% and preferably at least 90% of the elementary filaments of the fibre are individually continuous.
Each core multifilament textile fibre and/or outer-layer multifilament textile fibre comprises more than 10 elementary filaments, preferably more than 100 elementary filaments and more preferably more than 1000 elementary filaments.

In one embodiment of a bead wire of the type having one layer, the outer-layer yarn is wound in contact with the core.

In another embodiment of a bead wire of the type having a plurality of layers, the bead wire comprises at least one intermediate layer comprising a single yarn wound around the core, said intermediate layer being disposed between the core and the outer layer.

Optionally, the intermediate-layer yarn is wound in contact with the core.

Preferably, the intermediate-layer yarn comprises at least one intermediate-layer multifilament textile fibre embedded in an organic intermediate-layer matrix.

The intermediate-layer multifilament textile fibres and organic intermediate-layer matrices that are used may be chosen from those described with reference to the core fibres and outer-layer fibres and organic core matrices and organic outer-layer matrices. Preferably, the intermediate-layer multifilament textile fibre is a glass fibre and the organic intermediate-layer matrix is a thermoset resin.

In one embodiment, the materials of which the core, the outer layer and the intermediate layer are made are more or less identical. In another embodiment, at least two materials are different.

In one embodiment, the core fibre, outer-layer fibre and intermediate-layer fibre are more or less identical. In another embodiment, they are different.

In one embodiment, the organic core matrix, organic outer-layer matrix and organic intermediate-layer matrix are more or less identical. In another embodiment, at least two are different.

Advantageously, the extension and bending moduli of the core material and/or outer-layer material and/or intermediate-layer material that are measured in accordance with the standards ASTM D 638 and ASTM D 790, respectively, at 23° C. are preferably greater than 15 GPa, more preferably greater than 30 GPa, in particular between 30 and 50 GPa, inclusive. Preferably, the extension modulus of the organic core matrix and/or organic outer-layer matrix and/or organic intermediate-layer matrix that is measured in accordance with the standard ASTM D 638 at 23° C. is greater than or equal to 2.3 GPa, preferably greater than or equal to 2.5 GPa and more preferably greater than or equal to 3 GPa.

Optionally, the core material and/or outer-layer material and/or intermediate-layer material has elastic deformation in compression at least equal to 2%, preferably to 3%. Preferably, the core material and/or outer-layer material and/or intermediate-layer material has, in flexion, a breaking stress in compression greater than its breaking stress in extension.

The mechanical bending properties of the core material and/or outer-layer material and/or intermediate-layer material are measured with the aid of a tensile testing machine of the type 4466 from the company Instron.

The compressive properties are measured on the core material and/or outer-layer material and/or intermediate-layer material by the method referred to as the loop test (D. Sinclair, J. App. Phys. 21, 380 (1950)). In the present use of this test, a loop is produced and is brought progressively to its breaking point. The nature of the break, which is easily observable on account of the large size of the cross section, makes it immediately possible to recognize the breaking of the core material in extension or in compression.

Preferably, it will be noted that the core material, loaded in bending until it breaks, breaks on the side where the material is in extension, this being identified by simple visual observation.

Given that in this case the dimensions of the loop are large, it is possible at any time to read the radius of the circle inscribed in the loop. The radius of the circle inscribed just before the breaking point corresponds to the critical radius of curvature.

It is denoted Rac. The following formula then makes it possible to determine by calculation the critical elastic deformation: ecr=r/(Rac+r), where r corresponds to the radius of the material.

The breaking stress in compression is obtained by calculation using the following formula: σc=ecr.Me, where Me is the extension modulus. Since, in the case of the core material and/or outer-layer material and/or intermediate-layer material, the loop breaks in the part in extension, the conclusion is drawn that, in flexion, the breaking stress in compression is greater than the breaking stress in extension.

Breaking in flexion of a rectangular bar by the method referred to as the three failures method is also carried out. This method corresponds to the standard ASTM D 790. This method also makes it possible to verify, visually, that the nature of the break is indeed in extension.

The glass transition temperature Tg of the organic core matrix and/or organic outer-layer matrix and/or organic intermediate-layer matrix is preferably greater than 130° C., more preferably greater than 140° C. The glass transition temperature is measured in accordance with the standard ASTM D 3418.

The fibre content of the core material and/or outer-layer material and/or intermediate-layer material is advantageously between 30% and 80%, inclusive, of the overall mass of the material. Preferably, the fibre content is between 50% and 80%, inclusive, of the mass of the core material and/or outer-layer material and/or intermediate-layer material. The content by mass of fibres, expressed in per cent, is calculated by dividing the mass of 1 m of fibres, obtained from the titre, by the linear density of the core material and/or outer-layer material and/or intermediate-layer material.

Advantageously, the density of the core material and/or outer-layer material and/or intermediate-layer material is less than or equal to 2.2, preferably less than or equal to 2.05 and more preferably less than or equal to 1.6. Preferably, the density of the core material and/or outer-layer material and/or intermediate-layer material is between 1.4 and 2.05, inclusive, in which range the material has the best compromise between mass and mechanical properties, in particular the force at break. The density of the core material and/or outer-layer material and/or intermediate-layer material is measured by means of a specialist balance of the type PG503 DeltaRange from the company Mettler Toledo. Specimens of a few centimetres are successively weighed in air and dipped into methanol; the software of the apparatus then determines the density; the density is the average of three measurements.

A further subject of the invention is a tyre comprising at least one bead wire as defined above.

Preferably, the tyre is for a ground vehicle. A ground vehicle is understood to be any vehicle apart from aircraft. Preferably, the tyre is for a passenger vehicle.

As a variant, the tyre is for an aircraft.

The invention will be better understood on reading the following description, which is given solely by way of nonlimiting example, with reference to the drawings in which:

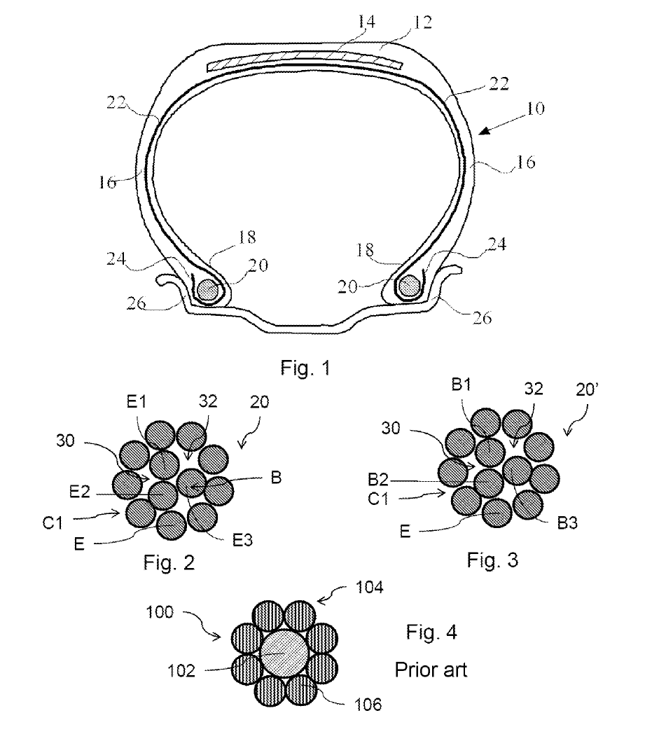

FIG. 1 is a perspective view of a tyre according to the invention;

FIGS. 2 and 3 are views in section perpendicular to the axis of the bead wire (which is assumed to be straight and at rest) of a bead wire according to first and second embodiments of the invention;

FIG. 4 is a view similar to that of FIGS. 2 and 3 of a prior art bead wire.

FIG. 1 shows a tyre according to the invention, denoted by the general reference 10. In this case, the tyre 10 is intended to be fitted on a ground vehicle, in this case a passenger vehicle, and has dimensions of 205/55 R16. As a variant, the tyre 10 is a tyre for an aircraft.

The tyre 10 has a crown 12 reinforced by a crown reinforcement 14, two sidewalls 16 and two beads 18, each of these beads 18 being reinforced with an annular bead wire 20. The crown 12 is surmounted by a tread, not shown in this schematic figure. A carcass reinforcement 22 is wound around the two bead wires 20 in each bead 18 and comprises a turn-up 24 disposed towards the outside of the tyre 20, which is shown fitted onto a wheel rim 26 here. The carcass reinforcement 22 is made up of at least one ply reinforced with cords. The reinforcement 22 is of the radial type.

Each bead wire 20 has a toroidal overall shape about an axis and has an approximately circular cross section. As a variant, the bead wire 20 has a polygonal, for example square, rectangular or hexagonal, cross section or even an elliptical or oblong cross section.

FIG. 2 shows a bead wire 20 according to a first embodiment of the invention.

The bead wire 20 comprises a core 30 and an outer layer C1. The diameter Dt of the torus defined by the bead wire 20 is equal to 6.3 mm.

The core 30 comprises a plurality of circumferential windings E1, E2, E3 of at least one core yarn B. In this case, the core 30 comprises three circumferential windings E1, E2, E3 of a single core yarn B. In this case, each circumferential winding E1, E2, E3 forms a coil of which the axis is in common with that of the bead wire 20. Thus, each winding E1, E2, E3 has a circular overall shape in projection in a plane perpendicular to the axis of the bead wire.

Traverse winding of the yarn B over a number of turns is carried out such that the core 30 has a substantially polygonal, in this case triangular, cross section. The diameter of the yarn B is between 0.5 and 4 mm. The diameter Da of the torus defined by the core 30 and in which the core 30 is inscribed is equal to 3.28 mm.

The yarn B is made of a core material Ma comprising a core multifilament textile fibre embedded in an organic core matrix. The core multifilament textile fibre is a glass fibre and the organic core matrix is a thermoset resin. The multifilament textile fibre is continuous. As a variant, the textile fibre is discontinuous.

The outer layer C1 comprises a single outer-later yarn E wound in a helix around the core 30 and in contact therewith. The single yarn E has a diameter Df equal to 1.52 mm. The single yarn E is made of an outer-layer material Mc comprising an outer-layer multifilament textile fibre embedded in an organic outer-layer matrix. The outer-layer multifilament textile fibre is a glass fibre and the organic outer-layer matrix is a thermoset resin.

In this case, the core material Ma and outer-layer material Mc are more or less identical. As a variant, the core material Ma and outer-layer material Mc are different.

The glass fibre comprises more than 10 elementary glass filaments, preferably more than 100 and more preferably more than 1000 elementary filaments arranged side by side and thus more or less parallel to one another, apart from the occasional overlap. The diameter of each elementary filament of the textile fibre is between 2 and 30 μm.

The glass fibre or glass fibres used may be of the “E” or “R” type.

The thermoset resins of the core and outer layer are of the vinyl ester type. Without this definition being limiting, the vinyl ester resin is preferably of the epoxy vinyl ester type. Use is more preferably made of a vinyl ester resin, in particular of the epoxy type, which, at least in part, is based on novolac (also known as phenoplast) and/or bisphenol (that is to say is grafted onto a structure of this type), or preferably a vinyl ester resin based on novolac, bisphenol, or novolac and bisphenol, as described for example in applications EP 1 074 369 and EP 1 174 250. An epoxy vinyl ester resin of the novolac and bisphenol type has shown excellent results; by way of examples, the vinyl ester resins “ATLAC 590” or “ATLAC E-Nova FW 2045” from the company DSM (both diluted with styrene) may be mentioned in particular. Such epoxy vinyl ester resins are available from other manufactures, such as Reichhold, Cray Valley, UCB.

The core yarn B and the outer-layer yarn E are monolithic and are manufactured for example by impregnation of each fibre as described in document U.S. Pat. No. 3,730,678, or by injection of the organic matrix into a mould in which each fibre has previously been placed, or as described in document EP1167080.

The yarn E of the outer layer C1 is wound in a helix around the core 30 over a number of turns, in this case over 10 turns, such that the layer C1 is saturated, that is to say there is not enough room between adjacent windings to be able to insert an additional winding. The yarn E is wound over 10 turns on account of the spacing that exists between the three windings of the core 30 in the position of mechanical equilibrium of the bead wire 20. The two ends of the yarn E are connected by means of a sleeve.

FIG. 3 shows a bead wire 20′ according to a second embodiment of the invention. Elements similar to those shown in the preceding figures are denoted by identical references.

In contrast to the bead wire 20 according to the first embodiment, the core 30 comprises a plurality of separate yarns B1, B2, B3. In this case, the core 30 comprises a plurality of monolithic toruses that are juxtaposed parallel to one another, each torus forming a yarn B1, B2, B3. The axis of each yarn B1, B2, B3 is in common with that of the bead wire 20′. The yarns are side by side such that the core 30 has a substantially polygonal, in this case triangular, cross section. The diameter Da of the torus defined by the core 30 and in which the core 30 is inscribed is equal to 3.60 mm.

All of the core yarns B1, B2, B3 are made of the same core material. For example, the core yarns B1, B2, B3 are made of the material Ma of the yarn B. As a variant, the core yarns B1, B2, B3 are made of at least two different core materials. The diameter of each yarn B1, B2, B3 is between 0.5 and 4 mm.

The tyre 10 illustrated in FIG. 1 comprises two bead wires 20 according to the first embodiment. A similar tyre 10′ according to the second embodiment (not shown) comprises two bead wires 20′ according to the second embodiment.

FIG. 4 shows a prior art bead wire denoted by the general reference 100.

In contrast to the bead wire according to the invention, the bead wire 100 comprises a metal core 102 that consists of a wire made of a steel having a carbon content equal to 0.1%. The diameter Da of the torus defined by the core 102 is equal to 2.15 mm. The bead wire 100 comprises an outer layer 104 comprising a wire 106 wound around the core 102. The wire 106 of the outer layer 104 has a diameter Df equal to 1.30 mm and is made of steel having a carbon content equal to 0.7%. The diameter of the torus Dt defined by the bead wire 100 is equal to 4.8 mm.

Comparative Measurements

The bead wires 20, 20′ according to the first and second embodiments and the prior art bead wire 100 were compared. The tyres 10, 10′ according to the first and second embodiments and a prior art tyre comprising two prior art bead wires 100 were also compared.

The characteristics resulting from the measurements carried out are summarized in Table 1 below.

TABLE 1

| | Bead wire tested | | | | | |
|---|---|---|---|---|---|---|
| | Bead wire | | Bead wire | | Bead wire | |
| | 100 | | 20 | | 20′ | |
| Mass | 149 | g | 54 | g | 54 | g |
| Force at break (Fm) | 1875 | daN | 2108 | daN | 2165 | daN |
| Burst pressure | >17 | bar | >17 | bar | >17 | bar |
| Yield strength of the | 700 | MPa | >1000 | MPa | >1000 | MPa |
| core material (Re) | | | | | | |
| Young's modulus (E) | 205 | GPa | 40 | GPa | 40 | GPa |
| Diameter of the torus | 4.8 | mm | 6.3 | mm | 6.5 | mm |
| (Dt) | | | | | | |
| Diameter of the core | 2.15 | mm | 3.28 | mm | 3.60 | mm |
| (Da) | | | | | | |

| | | | |
|---|---|---|---|
| Rd = Da/Dt | 0.45 | 0.52 | 0.55 |
| Contribution of the core | 11% | 23% | 26% |
| to the force at break of | | | |
| the bead wire (Rf) | | | |
| Contribution of the core | 25% | 23% | 26% |
| to the mass of the bead | | | |
| wire (Rm) | | | |
| R = Rm/Rf | 2.27 | 1 | 1 |

Each bead wire 20, 20′ makes it possible to maintain excellent mechanical characteristics, in particular force at break, while reducing the mass of the prior art bead wire 100 by 64% and avoiding any risk of irreversible plastic deformation.

Furthermore, each tyre 10, 10′ has a burst strength identical to the prior art tyre.

The force at break Fm of each bead wire 20, 20′ is between 1600 daN and 2600 daN, inclusive, preferably between 1800 daN and 2400 daN, inclusive, and more preferably between 2000 daN and 2200 daN, inclusive. Thus, with a mass much less than that of the prior art bead wire 100, each bead wire 20, 20′ has a force at break greater than that of the bead wire 100.

The ratio Rd of the diameter Da of the torus defined by the core 30 to the diameter Dt of the torus defined by each bead wire 20, 20′ is greater than or equal to 0.3, preferably greater than or equal to 0.45 and more preferably greater than or equal to 0.5.

The contribution Rm of the core 30 to the mass of the bead wire 20 is greater than or equal to 10%, preferably greater than or equal to 15% and more preferably greater than or equal to 20%. This contribution Rm is less than or equal to 75% for the bead wires 20, 20′.

The contribution Rf of the core 30 to the force at break Fm of the bead wire 20 is greater than or equal to 15%, preferably greater than or equal to 20% and more preferably greater than or equal to 25%. This contribution Rf is less than or equal to 75% for each bead wire 20, 20′.

At an equal contribution of the core to the mass of the bead wire, the core of each bead wire 20, 20′ has a greater contribution to the force at break of the bead wire, i.e. more than 2 times greater than that of the bead wire 100.

The ratio R of the contribution Rm to the contribution Rf is less than or equal to 2, preferably less than or equal to 1.5 and more preferably less than or equal to 1. This ratio R is greater than or equal to 0.25, preferably greater than or equal to 0.4 and more preferably greater than or equal to 0.5. Advantageously, the ratio R is equal to 1.

The core material Ma and layer material Mc of each bead wire 20, 20′ has a yield strength Re measured in accordance with the standard ISO 14125 at 23° C. greater than or equal to 800 MPa, preferably greater than or equal to 1000 MPa and more preferably greater than or equal to 1200 MPa.

The core material Ma and layer material Mc of each bead wire 20, 20′ has a Young's modulus E measured in accordance with the standard ISO 14125 at 23° C. less than or equal to 100 GPa, preferably less than or equal to 75 GPa and more preferably less than or equal to 50 GPa.

The invention is not limited to the embodiment described above.

Specifically, the bead wire according to the invention can be fitted on any type of tyre. For example, the bead wire may be intended for a tyre for industrial vehicles chosen from vans, heavy vehicles—i.e. metro vehicles, buses, road transport vehicles (lorries, tractors, trailers), off-road vehicles, aircraft—, agricultural or construction plant machinery, and other transport or handling vehicles.

In a variant (not shown) of a bead wire of the type having a plurality of layers, the bead wire comprises at least one intermediate layer comprising a single yarn wound in a helix around the core, said intermediate layer being disposed between the core and the outer layer. The single intermediate-layer yarn is wound in a helix in contact with the core. In this variant, the single intermediate-layer yarn is made of an intermediate-layer material comprising an intermediate-layer multifilament textile fibre embedded in an organic intermediate-layer matrix.

The intermediate-layer multifilament textile fibre and organic intermediate-layer matrix that are used may be chosen from those described with reference to the core fibre and outer-layer fibre and organic core matrix and organic outer-layer matrix. Preferably, the intermediate-layer multifilament textile fibre is a glass fibre and the organic intermediate-layer matrix is a thermoset resin.

In one embodiment, the core comprises a plurality of windings of a plurality of separate yarns that are assembled by cabling or twisting.

Moreover, the characteristics of the different embodiments can be combined with one another in any way, as long as they are compatible with one another.

It will be noted that it is possible to use a bead wire for a tyre, comprising:
a core comprising a plurality of circumferential windings of at least one core yarn,
an outer layer comprising a single outer-layer yarn wound around the core, each core yarn and outer-layer yarn having a yield strength measured in accordance with the standard ISO 14125 at 23° C. greater than or equal to 800 MPa, preferably greater than or equal to 1000 MPa and more preferably greater than or equal to 1200 MPa, independently of the fact that the bead wire comprises:
a core comprising a plurality of circumferential windings of at least one core yarn, each core yarn comprising a core multifilament textile fibre embedded in an organic core matrix,
an outer layer comprising a single outer-layer yarn comprising an outer-layer multifilament textile fibre embedded in an organic outer-layer matrix, the outer-layer yarn being wound around the core.

1-21. (canceled)

22: A bead wire for a tyre, the bead wire comprising:
a core that includes a plurality of circumferential windings of at least one core yarn, each core yarn including a core multifilament textile fibre embedded in an organic core matrix; and
an outer layer that includes a single outer-layer yarn, the single outer-layer yarn including an outer-layer multifilament textile fibre embedded in an organic outer-layer matrix,
wherein the outer-layer yarn is wound around the core.

23. The bead wire according to claim 22, wherein the core includes a single core yarn.

24. The bead wire according to claim 22, wherein the core includes a plurality of separate core yarns.

25. The bead wire according to claim 22, wherein a material of which each core yarn, or the outer-layer yarn, or both the other-layer yarn and each core yarn is made has a yield strength greater than or equal to 800 MPa, measured in accordance with a standard ISO 14125 at 23° C.

26. The bead wire according to claim 22, wherein a material of which each core yarn, or the outer-layer yarn, or both the outer-layer yarn and each core yarn is made has a Young's modulus less than or equal to 100 GPa, measured in accordance with the standard ISO 14125 at 23° C.

27. The bead wire according to claim 22, wherein a ratio of a contribution of the core to a mass of the bead wire to a contribution of the core to a force at break of the bead wire is less than or equal to 2.

28. The bead wire according to claim 27, wherein the ratio of the contribution of the core to the mass of the bead wire to the contribution of the core to the force at break of the bead wire is greater than or equal to 0.25.

29. The bead wire according to claim 22, wherein a contribution of the core to a force at break of the bead wire is greater than or equal to 15%.

30. The bead wire according to claim 29, wherein the contribution of the core to the force at break of the bead wire is less than or equal to 75%.

31. The bead wire according to claim 22, wherein a contribution of the core to a mass of the bead wire is greater than or equal to 15%.

32. The bead wire according to claim 31, wherein the contribution of the core to the mass of the bead wire is less than or equal to 75%.

33. The bead wire according to claim 22, wherein a ratio of a diameter of a torus defined by the core to a diameter of a torus defined by the bead wire is greater than or equal to 0.3.

34. The bead wire according to claim 22, wherein a force at break of the bead wire is between 1600 daN and 2600 daN.

35. The bead wire according to claim 22, wherein a diameter of each core yarn, or the outer-layer yarn, or both the other-layer yarn and each core yarn is between 0.5 and 4 mm.

36. The bead wire according to claim 22, wherein a diameter of each elementary filament of each core multifilament textile fibre, or each outer-layer multifilament textile fibre, or each core multifilament textile fibre and outer-layer multifilament textile fibre is between 2 and 30 μm.

37. The bead wire according to claim 22, wherein each core multifilament textile fibre, or each outer-layer multifilament textile fibre, or each core multifilament textile fibre and outer-layer multifilament textile fibre is continuous.

38. The bead wire according to claim 22, wherein each core multifilament textile fibre, or each outer-layer multifilament textile fibre, or each core multifilament textile fibre and outer-layer multifilament textile fibre includes more than 10 elementary filaments.

39. The bead wire according to claim 22, wherein each core multifilament textile fibre, or each outer-layer multifilament textile fibre, or each core multifilament textile fibre and outer-layer multifilament textile fibre is chosen from a group of fibres consisting of: glass fibres, carbon fibres, silica fibres, ceramic fibres, and mixtures thereof.

40. The bead wire according to claim 22, wherein one or both of the organic core matrix and the organic outer-layer matrix is a thermoset type of matrix.

41: A tyre comprising at least one bead wire, the bead wire including:
a core that includes a plurality of circumferential windings of at least one core yarn, each core yarn including a core multifilament textile fibre embedded in an organic core matrix; and
an outer layer that includes a single outer-layer yarn, the single outer-layer yarn including an outer-layer multifilament textile fibre embedded in an organic outer-layer matrix,
wherein the outer-layer yarn is wound around the core.
